(19) United States
(12) Patent Application Publication
(10) Pub. No.: US 2010/0021638 A1
(43) Pub. Date: Jan. 28, 2010

(54) METHOD FOR FABRICATING THREE DIMENSIONAL MODELS

(75) Inventors: Michael VARANKA, Amherst, NH (US); John Theodore WIGAND, Merrimack, NH (US); Calvin McCoy WINEY, Peterborough, NH (US)

Correspondence Address: DAVIS & BUJOLD, P.L.L.C., 112 PLEASANT STREET, CONCORD, NH, 03301, US

(73) Assignee: SOLIDSCAPE, INC., Merrimack, NH (US)

(21) Appl. No.: 12/509,849

(22) Filed: Jul. 27, 2009

Related U.S. Application Data
(60) Provisional application No. 61/137,189, filed on Jul. 28, 2008.

(51) Int. Cl. B05D 3/00

(52) U.S. Cl. 427/271

(57) ABSTRACT

A method for fabricating a three dimensional model by fabricating a composite model formed of a plurality of successive layers comprised of one or more materials wherein each successive layer is formed by depositing at least first material delineating boundaries of at least one first area of the layer by a drop-by-drop deposition and depositing at least a second material over the layer by a rapid deposition method, and may include the deposition of a third material by a drop-by-drop or rapid deposition method and will include planing the layer to a uniform thickness and selectively removing the first and second materials, and third material if present, by successive removal methods, each of which effects only one of the materials.

### CROSS REFERENCES TO RELATED APPLICATIONS

The present Patent Application is related to and claims benefit of Provisional Patent Application Ser. No. 61/137,189 filed Jul. 28, 2008 by John Theodore WIGAND, Calvin McCoy WINEY III and Michael VARANKA for a METHOD AND APPARATUS FOR FABRICATING THREE DIMENSIONAL MODELS, and is further related to and claims benefit of U.S. patent application Ser. No. 11/445,516 filed Jun. 2, 2006 by John Theodore WIGAND, Calvin McCoyWINEY III and Michael VARANKA for a METHOD AND APPARATUS FOR FABRICATING THREE DIMENSIONAL MODELS, corresponding PCT Patent Application Serial No. PCT/US2006/029696 filed Jul. 28, 2006, both of which are assigned to the assignee of the present Patent Application, and corresponding U.S. Patent Publication No. 2007/0029693 Al. U.S. patent application Ser. No. 11/445,516 is in turn related to and claims benefit of Provisional Patent Application Ser. No. 60/705,138 filed Aug. 3, 2005 by John Theodore Wigand, Calvin McCoy Winey III and Michael Varanka for a SPRAY JET DEVICE FOR FABRICATING THREE DIMENSIONAL MODELS, Provisional Patent Application Ser. No. 60/704,854 filed Aug. 2, 2005 by John Theodore Wigand for a METHOD FOR FABRICATING THREE DIMENSIONAL MODELS, Provisional Patent Application Ser. No. 60/704,855 filed Aug. 2, 2005 by John Theodore Wigand and Calvin McCoy Winey III for a DEVICE FOR FABRICATING THREE DIMENSIONAL MODELS, all of which are assigned to the assignee of the present Patent Application.

### FIELD OF THE INVENTION

The invention relates to an improved deposition methods and techniques for fabricating precise three dimensional models at increased speed as well as improved techniques for separating the three dimensional models from the rapid deposition material.

### BACKGROUND OF THE INVENTION

Contemporary design processes often require the rapid fabrication of prototypes and models of complex mechanical parts in low volumes and with minimum setup and fabrication times to allow the evaluation and testing of the design of such parts within very short design and development periods. Most conventional fabrication methods, however, are unsuitable for such purposes. Manual machining, for example, is sometimes suitable for relatively simple designs but is too slow and expensive for complex designs and Computer Numerically Controlled (CNC) machine processes, while suitable for complex designs, have significant limitations as regards the types or configurations of parts that can be fabricated.

The need for rapid, low cost, low volume fabrication of complex parts has generally been met by the development of various three dimensional (3D) modeling processes that employ layer by layer “printing” processes. In typical 3D modeling processes of the prior art, a part is built up by the successive deposition of layers generally comprising a “model” material forming the final part to be manufactured and a sacrificial material that provides support for the model material during the process, with the sacrificial material being subsequently removed to leave the model material forming the final part to be manufactured.

Typical examples of 3D modeling processes of the prior art include, for example, Householder, U.S. Pat. No. 4,247,508, which describes a modeling process that employs two substances, one a fill material and the other a mold material, that are deposited layer by layer to build an article. The two materials in each layer are not in contact with each other while the layer is being formed because Householder '508 uses a grid to separate the two materials as they are being deposited. After the materials in each layer are deposited, the grid is moved to the next layer so that the two materials may fill the space left by the removed grid and thereafter solidify in contact with each other in the same layer.

Helinski, U.S. Pat. No. 5,136,515, describes a method wherein a three dimensional model is produced layer by layer by jetting droplets of at least two solidifiable materials, one material forming the article and a second material forming a support for the article. The second material is subsequently removed by heating, cutting, melting, chemical reacting, and so on, to leave the desired article.

Penn, U.S. Pat. No. 5,260,009, describes a system and process for making three dimensional objects by dispensing layer upon layer of modeling material using an inkjet which is turned “on” or “off” according to a two dimensional data map of each layer of the object. The two dimensional data map is stored and relayed by a microprocessor and defines locations on a matrix at which printing is to occur in a manner such as is used in printing images using raster scan printing.

Sanders, Jr. et al., U.S. Pat. No. 5,506,607, describes a system for building three dimensional models by vector plotting layer-upon-layer applications of solidifiable substances. The layers are formed by expelling minuscule beads of the substances in a liquid or flowable phase onto a platform from one or more jets wherein the jets and platform are relatively movable in the X, Y and Z coordinate system and the beads are deposited along vectors during X-Y relative movement.

Sanders, Jr. et al., U.S. Pat. No. 5,740,051, describes a method and apparatus for producing a 3-D model by forming a continuous plurality of parallel layers of modeling material by repeatedly producing a plurality of bead producing drops of the modeling material for deposition at desired locations, controlling the locations and timing of deposition to produce vectors in any and all directions required to produce an outer surface defining a wall of a layer with a desired surface finish, and adjusting the distance of the location of drop production to the location of drop deposition in preparation for the formation of a subsequent layer.

Penn et al., U.S. Pat. No. 6,175,422, describes a method and process for computer-controlled manufacture of three dimensional objects by dispensing a layer of a first insoluble material, such as a liquid, onto a platform at predetermined locations corresponding to a cross-section of the object, which then hardens. A second material, preferably water soluble, is then sprayed onto this layer to thereby encapsulate the hardened insoluble material. The uppermost surface of this encapsulant is planed, thus removing a portion of the encapsulant to expose the underlying insoluble material for a new pattern deposition. After the resulting planing residue is removed, another layer of liquid, insoluble material is dispensed onto the planed surface. The insoluble material can be of any color and may vary from layer to layer, and from location within a layer to location with a layer. These steps are repeated, until the desired three dimensional object, encapsulted in the soluble material, is completed. At this point, the object is either heated or immersed in solvent, thereby dissolving the soluble material and leaving the three dimensional object intact.

In typical embodiments of the 3D modeling processes, therefore, examples of which have been described above, the modeling and sacrificial materials comprise two materials having differing mechanical and/or chemical characteristics with the differences between the modeling and sacrificial materials being such that the sacrificial material can be selectively removed after the fabrication is completed. For example, in some implementations the sacrificial material may have a lower melting temperature than the modeling material or may be dissolvable by a solvent that does not effect the modeling material. Less common implementations of 3D modeling processes, which are not pertinent to the present invention, may construct the part and its model sacrificial regions from a single material having two different physical states or phases, depending, for example, upon whether a given region has been radiated by a specific type of laser radiation or has been treated with a binding agent or solvent, thereby converting treated and untreated regions of the material into the equivalent of modeling and sacrificial material.

The layers are typically laid down one layer at a time and one region or line of material at a time in a raster scan pattern by drop-by-drop deposition of the materials on a previous layer or base by drop-on-demand print heads generally similar to those used in ink jet printers. Each layer is then formed into a level, uniform surface upon which the next layer is deposited, typically by means of a roller or a “squeegee” type device to flatten or spread the material. This deposition and planing process is repeated numerous times until the fabricated composite structure is completed.

It must also be noted that the deposition of the drops of sacrificial or model material in a liquid or semi-liquid state requires that each drop be deposited onto a supporting surface—typically the previously deposited layer. This, in turn, requires that each layer extend at least the maximum horizontal extent of the layer above that layer, including those areas of a layer that lie under any overhanging or undercut regions of a part, although such temporary supporting areas of the layers may be subsequently removed when the modeling process is completed.

It will therefore be apparent that the 3D modeling systems of the prior art suffer from a number of inherent disadvantages. For example, the deposition of the model and sacrificial material on a drop-by-drop basis is very time consuming, particularly when a significant proportion of the material is subsequently sacrificed, or wasted, in order to obtain the final part to be manufactured. In addition, the requirement that each layer must be fully supported by a lower layer requires that each layer provide a platform or support for the entire maximum horizontal model and support dimensions of the layer above it. In a typical part, however, much of the deposited material is thereby merely sacrificial material that must be subsequently removed, so that much of the deposited material, as well as the time required to deposit the material, is effectively wasted with respect to the final part.

In addition, drop-by-drop deposition requires the use of at least two drop-on-demand print heads, one for each material, and typical systems of the prior art often employ several drop-on-demand print heads to allow several streams of drops to be concurrently deposited. The user of multiple drop-on demand print heads, however, significantly increases the complexity and cost of the system. In addition, drop-on-demand print heads typically have relatively small jetting orifices, which limit the rate at which material can be deposited, limit the types of material that can be deposited to those materials capable of being ejected as drops through a small orifice, and reduce print head reliability because the small orifices are more readily subject to blockage.

In addition, it has often been difficult, in systems or the prior art, to achieve the desired dimensional tolerances, surface textures and finished part quality.

The closest prior art to the present invention is believed to be U.S. Patent Publication No. 2007/0029693 A1, which corresponds to U.S. patent application Ser. No. 11/445,516 filed Jun. 2, 2006 by John Theodore WIGAND, Calvin McCoyWINEY III and Michael VARANKA for a METHOD AND APPARATUS FOR FABRICATING THREE DIMENSIONAL MODELS and PCT Patent Application Serial No. PCT/US2006/029696 filed Jul. 28, 2006 (“U.S. Patent Publication No. 2007/0029693 A1”).

U.S. Patent Publication No. 2007/0029693 A1 relates to a method and apparatus for fabricating three dimensional models using a layer-by-layer approach that provides a significant improvement with respect to model dimensional accuracy and surface finish and the time required for fabrication of such parts or structures. As described therein, and as will be described further in the following Description of the Invention, the method and apparatus described in U.S. Patent Publication No. 2007/0029693 A1 fabricate a finished model by constructing a composite model comprising a plurality of layers formed by first depositing boundaries formed of a sacrificial mold materials on a drop-by-drop basis. A model material is then deposited on the entire layer, including both the previously formed boundaries of sacrificial mold material and the regions of the model to be formed of the model material, by a high flow rate deposition method, such as spraying, after which any sacrificial mold material and any model material that exceeds the specified layer thickness, including model material that has been deposited on top of the mold material boundaries, are removed, preferably by a planing device. The process is repeated on a layer by layer basis until the composite model is completed, whereupon the sacrificial mold material is removed from the composite model, leaving the model material to comprise the finished model.

It should be noted that the method and apparatus described in U.S. Patent Publication No. 2007/0029693 A1 also provides an improved method for forming temporary support for overlying layers forming overhanging, cantilevered and/or undercut regions and temporary filling of regions that are to be comprised of voids in the finished model. Briefly, in the method for forming temporary support or void regions described in U.S. Patent Publication No. 2007/0029693 A1 the temporary support or void filler regions are either formed entirely of sacrificial mold material or of filler elements, or “cubes” of model material bounded and separated from one another and the surrounding structural elements of the model by boundaries comprised of sacrificial mold material. The “cube” boundaries of mold material are subsequently sacrificed from the model, thereby leaving the “cubes” of model material free to fall away and leaving, for example, the desired void.

The method and apparatus described in U.S. Patent Publication No. 2007/0029693 A1 thereby offers significant advantages over previous methods and apparatus of the prior art, such as faster and more efficient forming of the model material regions of the model by high flow rate deposition of the model material. The method still, however, requires the time consuming drop-by-drop deposition of significant amounts of mold material, particularly in forming the sacrificial “cubes” for temporary support of overhanging, cantilevered and/or undercut regions and temporary filling of voids, as well as possible difficulties in subsequently removing the “cubes”.

### SUMMARY OF THE INVENTION

Wherefore, it is an object of the present invention to overcome the above mentioned shortcomings and drawbacks associated with the prior art.

Another object of the present invention is to increase the fabrication speed of a model by reducing the amount of drop-on-demand material required to form the model.

Yet another object of the present invention is to provide the ability to use either the surface of the rapid deposition material or the exterior surface of the shell formed by the drop-on-demand material as the exterior surface of the finished three dimensional model once either the rapid deposition material, located outside the shell of the drop-on-demand material, is removed or once both the exterior rapid deposition material and the shell of drop-on-demand material are removed thereby leaving the finished three dimensional model.

A still further object of the present invention is to provide a sufficiently thick exteriors hell formed by the drop-on-demand material, e.g., an exterior shell having a thickness of at least one drop and preferably 2 to 6 drops, to ensure that when the fabricated composite structure is placed in a solvent for example, for removing the rapid deposition material from the exterior surface of the drop-on-demand material, all of the rapid deposition material is easily, rapidly and reliably dissolved and/or removed, e.g., within between 5 and 25 minutes, for example, thereby leaving a drop-on-demand material exterior shell completely encasing the rapid deposition material.

Another object of the present invention is to precisely deposit the drop-on-demand material on the platen, so that either the exterior surface of the drop-on-demand material, forming the shell encasing the deposition material, or the inwardly facing surface of the drop-on-demand material defined the exterior surface of the finished three dimensional model.

Still another object of the present invention is to deposit the rapid deposition material at a rate of between five (5) to about twenty (20) times faster and preferably about at least ten (10) times faster than the deposition rate of the drop-on-demand material to thereby increase the fabrication speed of each layer of the fabricated composite structure.

A further object of the present invention is to eliminate the formation of a grid or other support pattern, comprising both drop-on-demand material and rapid deposition material as a support layer for subsequent layers, and replace such pattern with a uniform layer of the rapid deposition material which facilitates more rapid building of the fabricated composite structure as well as easy and reliable dissolving and/or removing of the rapid deposition material virtually without any manual labor or other operator intervention.

Another object of the present invention is to deposit more than one layer of drop-on-demand material, prior to depositing the rapid deposition material, and thereby filling more than one boundary layer at the same time, and thereby facilitate a more rapid building of the fabricated composite structure while maintaining the external model surface finish associated with thinner shell layers.

Still another object of the present invention is to introduce a second rapid deposition material, i.e., a third material, that is used to fill voids and provide support for subsequent layer that is more readily removable than the first rapid deposition material permitting a richer repertoire of first rapid deposition materials.

The present invention is directed to a method for fabricating a three dimensional model in which the present invention includes the steps of fabricating a composite model formed of a plurality of successive layers wherein each layer includes at least one of a first material and second material and each successive layer is formed by the steps of: a) depositing at least one line of a first material delineating at least one boundary of at least one first area of the layer by a drop-by-drop deposition of the first material wherein the drops of the first material solidify, shortly after being deposited, to define the at least one boundary of the at least one area, b) depositing a second material onto at least a second area of the layer by a rapid deposition of the second material wherein the second area includes at least the first area, and c) removing a thickness of at least one of the first and second materials to reduce the fabricated layer to a selected thickness. Steps (a), (b) and (c) are repeated until the composite model is fabricated. The three dimensional model is then separated from the composite model by successive removal processes, each removal process including the removal of one of the first material and the second material by a corresponding removal method not effecting the other of the first and second materials.

According to a further aspect of the present invention, step (a) may further include the steps of (d) removing a thickness of the first material to reduce the layer to a selected thickness of the first material defining each boundary of each region and (e) repeating steps (a) and (d) to construct the outer boundary of at least one region of the layer to a thickness of layers of first material, wherein in step (b) the interior space of each region is filled with the second material to a desired thickness and, in step (c), a thickness of the second material is removed to reduce the layer to the selected thickness of the first material.

The method further includes the step of removing the three dimensional model from the composite model and successive removal processes for the first and the second materials so that (a) exterior surfaces of the final three dimensional model are formed of the first material, or (b) the exterior surfaces of the final three dimensional model are formed of the second material, or (c) removing the second material by a process effecting only the second material thereby leaving the first material which forms an exterior shell which defines an exterior surface of the three dimensional model, or (d) separating the three dimensional model from the composite model by removing the second material by a process effecting only the second material thereby leaving the first material which forms an exterior shell encasing the three dimensional model and subsequently removing the exterior shell of first material encasing the three dimensional model by a process effecting only the first material, thereby leaving only the second material which forms the three dimensional model.

In another embodiment of the present invention, the method includes the steps of (a) constructing a layer of the model by (al) defining on the layer an outer boundary of at least one region of the three dimensional model by depositing, for each region, a layer of a boundary of a first material enclosing the region; (a2) filling an interior space of each region with a second material wherein the second material is deposited at a rate faster than a rate than the first material is deposited; and (a3) removing a thickness of at least one of the first and second materials to reduce the layer to a selected thickness. Steps (a1) through (a3) are repeated until the composite model is completed and the three dimensional model is separated, from the composite model, by successive removal processes, each removal process including the removal of one of the first material and the second material by a corresponding removal method not effecting the other of the first and second materials.

In a further implementation of the invention, step (a1) may further include the steps of (d) removing a thickness of the first material to reduce the layer to a selected thickness of the first material defining each boundary of each region and (e) repeating steps (a1) and (d) to construct the outer boundary of at least one region of the layer to a thickness of layers of first material, wherein in step (a2) the interior space of each region is subsequently filled with the second material to a desired thickness, and in step (a3) a thickness of the second material is removed to reduce the layer to the selected thickness of the first material.

A yet further embodiment of the invention includes the steps of (1) fabricating a composite model formed of a plurality of successive layers wherein each layer includes at least one of a first material and second material and each successive layer is formed by the steps of (a) depositing at least one line of a first material delineating at least one boundary of at least one first area of the layer by a drop-by-drop deposition of the first material, (b) depositing a second material onto at least a second area of the layer by a rapid deposition method of the second material wherein the second area includes at least the first area and the deposition of the second material fills the first area to a level at least as high as the highest layer of the first material boundary, and (c) removing a thickness of at least one of the first material and the second material to reduce the thickness of the layer to a selected thickness of the first material. Steps (a), (b) and (c) are repeated until the composite model is fabricated, and the three dimensional model is separated from the composite model by successive removal processes, each removal process including the removal of one of the first material and the second material by a corresponding removal method not effecting the other of the first and second materials.

In a further implementation of the invention, step (a) may further include the steps of (a1) removing a thickness of the first material to reduce the layer to a selected thickness of the first material defining each boundary of each region and (a2) repeating steps (a) and (a1) to construct the outer boundary of at least one region of the layer to a thickness of layers of first material. In step (b) the interior space of each region is filled with the second material to a desired thickness and in step (c) a thickness of the second material is removed to reduce the layer to the selected thickness of the first material.

A still further embodiment of the present invention includes the steps of fabricating a composite model from a plurality of successive layers wherein each layer includes at least one of a first material, second and third material and successive layers are formed by the steps of (a) depositing at least one line of a first material delineating at least one boundary of at least one first area of the layer by a drop-by-drop deposition of the first material, (b) depositing a second material onto at least one second area of the layer by a rapid deposition method wherein the at least one second area includes at least one of the at least one first area, (c) depositing a third material onto at least one third area of the layer by one of a rapid deposition method and a drop-by-drop deposition wherein the at least one third area includes at least one area outside at least one of the at least one first area and the at least one second area, and (d) removing a thickness of the first material, the second material and the third material to reduce the layer to a selected thickness. Steps (a) through (d) are repeated until the composite model is fabricated and the three dimensional model is then separated from the composite model by successive removal processes wherein each removal process includes the removal of one of the first material, the second material and the third material by a corresponding removal method and wherein the removal method does not effect the other(s) of the first, second and third materials.

In a further implementation of the invention, step (a) may further include the steps of (a1) removing a thickness of the first material to reduce the layer to a selected thickness of the first material and (e) repeating steps (a) and (a1) to construct the outer boundary of at least one region of the layer to a thickness of layers of first material. In a further embodiment of this process, step (b) may further include the step of (b1) removing a thickness of the second material to reduce the layer to the selected thickness of the first material, and step (d) may comprise removal of a thickness of the third material to reduce the layer to the selected thickness of the first material, or any combination thereof.

In still further implementations of the invention, step (c) may comprise depositing the third material onto at least one third area of the layer, e.g., by typically a rapid deposition or possibly either a drop-by-drop deposition, and may further include depositing the second material onto at least one third area of the layer by rapid deposition.

In other implementations, the step of removing the three dimensional model from the composite model may include successive removal processes for the first, second and third materials so that exterior surfaces of the final three dimensional model are formed of the first material, or successive removal processes for the first, second and third materials so that exterior surfaces of the final three dimensional model are formed of the second material.

In yet another embodiment, the step of removing the three dimensional model from the composite model may include a common removal process for simultaneous removal of the second and the third materials that does not effect the first material, and the external surface(s) of the final three dimensional model are formed of the first material.

In a still further embodiment, the step of removing the three dimensional model from the composite model may include a common removal process for simultaneous removal of the second and the third materials, that does not effect the first material, followed by a separate removal process for removal of the first material that does not effect the second material, and the external surface(s) of the final three dimensional model are formed of the second material.

### BRIEF DESCRIPTION OF THE DRAWINGS

The invention will now be described, by way of example, with reference to the accompanying drawings in which:

FIG. 1A-1E illustrate an exemplary model to be fabricated by the method and apparatus described in U.S. Patent Publication No. 2007/0029693 A1 with FIG. 1A being a perspective view of a completed 3D model, FIGS. 1B, 1C and 1D are sectional views along the indicated section lines of FIG. 1A, and FIG. 1E is a sectional view along section line of 1E-1E of FIG. 1A prior to removal of the sacrificial mold material;

FIGS. 2A-2C illustrate the method of the present invention for fabricating successive layers of sacrificial material and model material by drop-on-demand and spray deposition of the materials;

FIGS. 3A and 3B illustrate a method described in U.S. Patent Publication No. 2007/0029693 A1 for fabricating voids and support elements using grids of sacrificial material and filler elements of model material separated by sacrificial material;

FIGS. 3C and 3D illustrate the method of the present invention for fabricating support voids and support elements;

FIGS. 4A-4E are summary illustrations of a process for fabricating a composite model;

FIGS. 5A-5C are summary illustrations of the method for fabricating a composite model;

FIG. 6 shows, for a number of different layers, the deposit pattern for both the perimeter drop on demand material and the bulk rapid deposition material as well as the resulting combination following planing or shaving off a small portion of the most recently deposited layer;

FIG. 6A shows the model formed by the different deposition layers of FIG. 6; and

FIGS. 7A-7C are summary illustrations of the method for removing selected mold and model material from the composite to leave a three dimensional model.

### DETAILED DESCRIPTION OF THE INVENTION

The method and apparatus of the present invention for fabricating three dimensional models is a further development and improvement of the method and apparatus for fabricating three dimensional models described U.S. Patent Publication No. 2007/0029693 A1 and provides a significant improvement with respect to the time required for fabrication of such parts or structures. As such, and in order to provide a context and description of the base technology of the present invention, the following will begin with a summarized description of the method and apparatus for fabrication of three dimensional models as described in U.S. Patent Publication No. 2007/0029693 A1, the contents of which are incorporated herein by reference.

A. Fabrication of Three Dimensional Models as Described in U.S. Patent Publication No. 2007/0029693 A1.

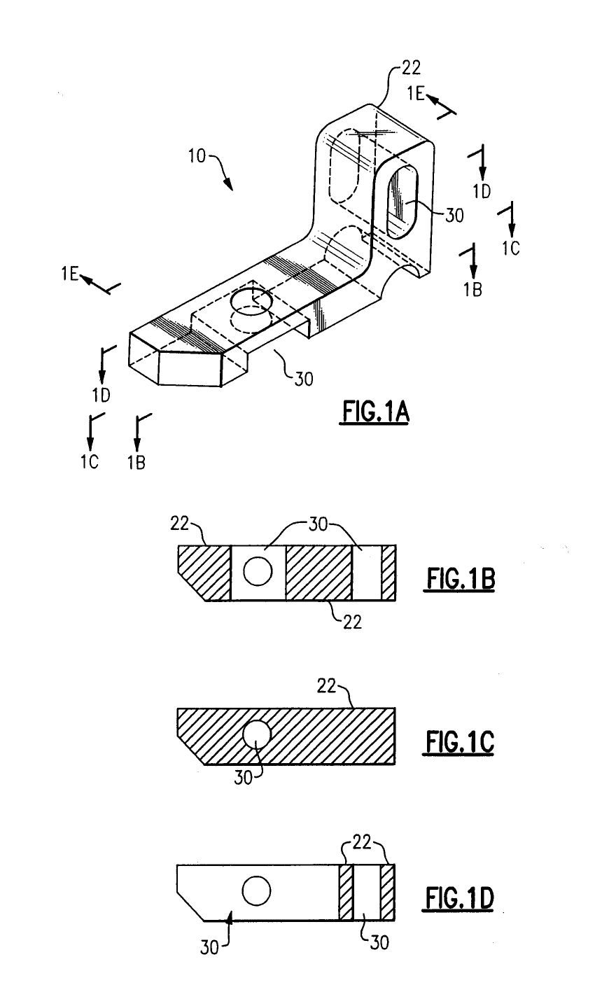

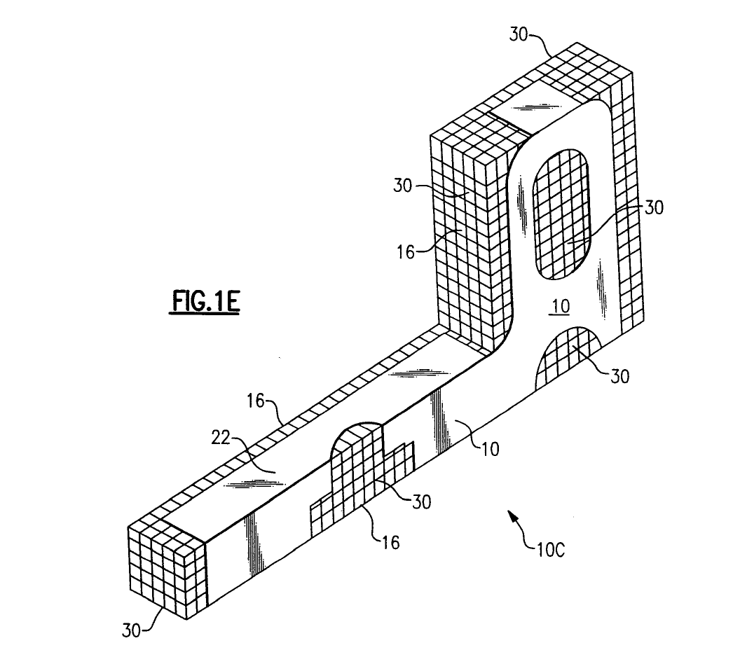

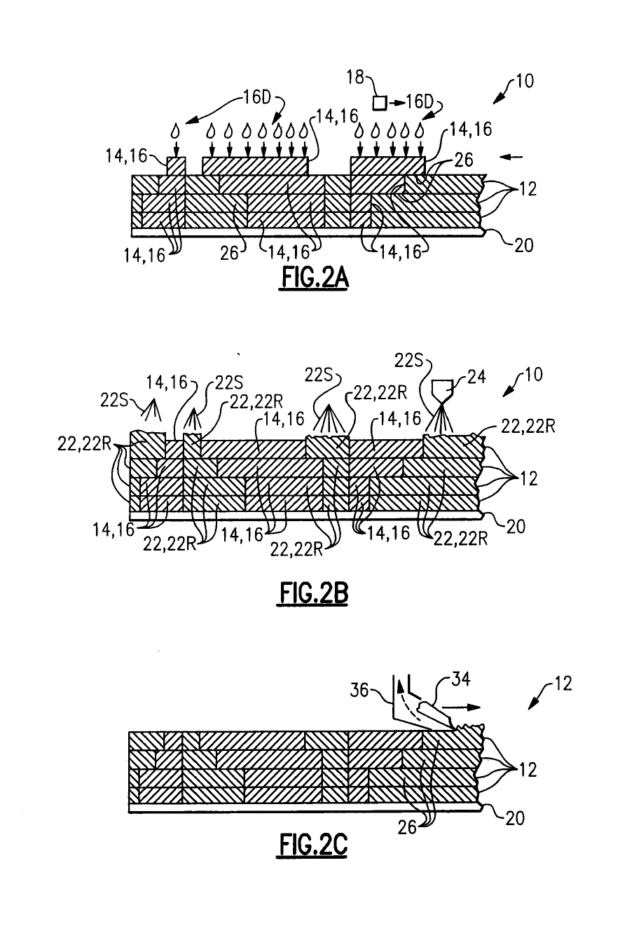

Therefore, first considering the basic method and apparatus for fabricating three dimensional models as described in U.S. Patent Publication No. 2007/0029693 A1, FIGS. 1A through 1E illustrate an exemplary finished model 10 (FIG. 1A) to be fabricated according to the method and the apparatus of the present invention and will be referred to in the following discussion. As represented in FIG. 1E for purposes of the following description, the apparatus and method of the present invention fabricates a finished model 10 (FIG. 1A) by constructing a composite model 10C (FIG. 1E) comprised of the finished model 10, which is formed of model material, and a sacrificial mold, which is formed of sacrificial mold material 16, and by subsequently removing the sacrificial mold material 16 from the composite model 10C to leave the finished model 10 (FIG. 1A).

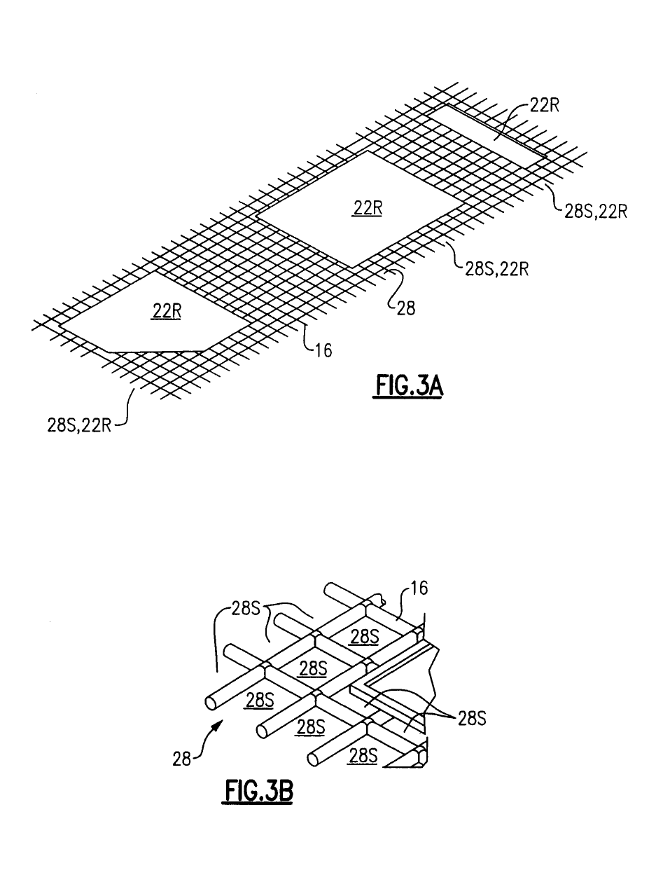

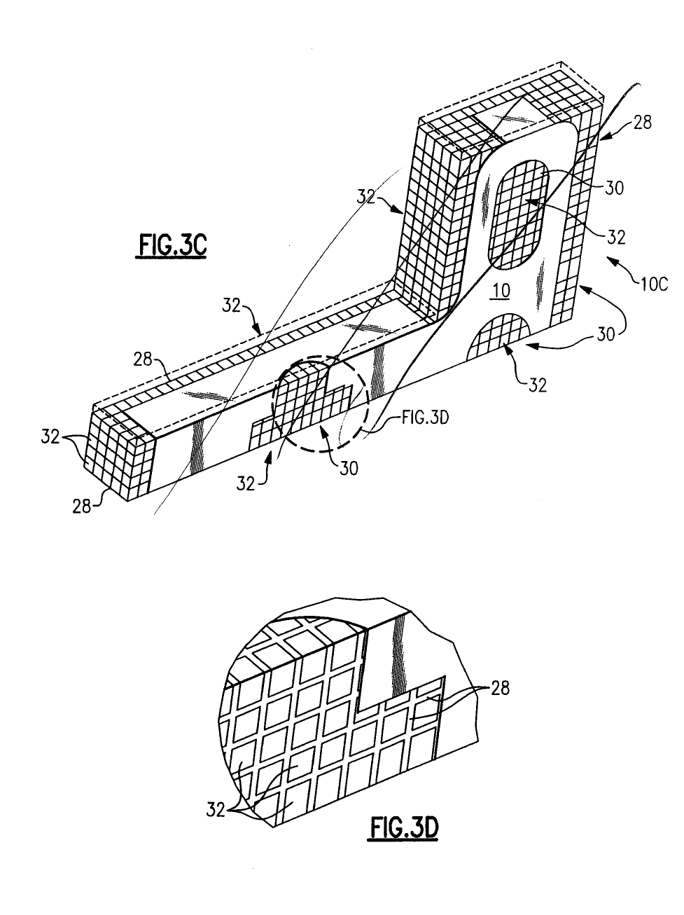

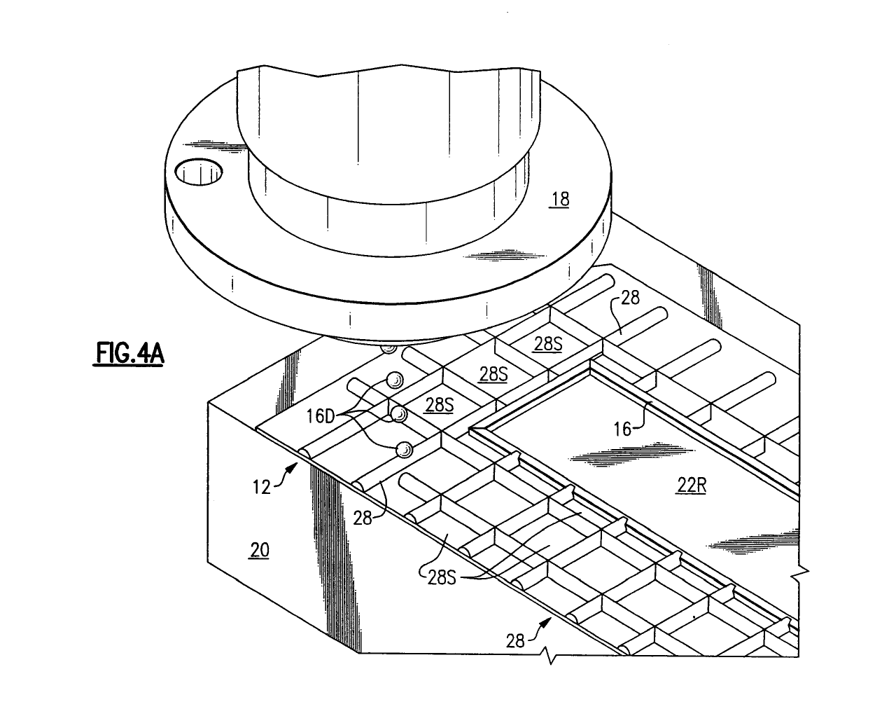

As illustrated in FIGS. 2A, 2B and 2C, the composite model 10C is comprised of a plurality of layers 12 wherein, as represented in FIG. 2A, each layer 12 is formed by first depositing boundaries formed of lines or areas 14 comprised of sacrificial mold material 16 that defines the surfaces of the finished model 10. As indicated, the sacrificial mold material 16 is deposited as drops 16D on a drop-by-drop basis by a drop-on-demand device 18. As also indicated, the first layer 12 may be deposited on a base 20 that may be comprised of any material suitable to accept the deposition of the sacrificial mold material and the model material, and thereafter each succeeding layer 12 will be deposited on the preceding layer 12.

As shown in FIG. 2B, one or more model materials 22 are then deposited on the layer 12. The model materials 22 are deposited on the regions 22R of the model defined by the sacrificial mold material 16 to receive and be filled by the model material 22 and to thereby comprise the actual finished model or part 10 after the sacrificial mold material 16 is removed. In contrast from the sacrificial mold material 16, however, the model material 22 is deposited by a high deposition rate device 24 at a faster rate than is achievable by the drop-on-demand device depositing the sacrificial mold material 16. The model material 22 is, for example, deposited as a spray 22S, that is, as a mist of droplets from ejected from the spray device 24.

After the model material 22 is deposited, any sacrificial mold material 16 and any model material 22 that exceeds the specified layer thickness for the layer being built are removed, such as by a planing operation, as illustrated in FIG. 2C, and the next layer 12 is then deposited upon the previous layer 12. This process is repeated until the last layer 12 is deposited and any excess material 16, 22 of that layer 12 is removed, and the sacrificial mold material 16 is then removed to leave the model material 22 comprising the model 10.

It must be noted with respect to the above description that the term “boundary”, as used within this specification and the appended claims, is intended to be construed broadly and cover any border, barrier, perimeter edge or surface which defines an internal mold, cavity or area which is to be subsequently filled with the model material, thereby forming a mold defining the exterior surfaces of the model material. The model material 22 is then deposited on the layer 12 as a spray within the boundary or boundaries defined by the sacrificial mold material 16, and the sacrificial mole material 16 is then removed to leave the model material 22 comprising the model 10.

Briefly considering the deposition of the sacrificial mold material 16 and the model material 22 in further detail, the sacrificial mold material 16 is typically deposited in liquid drop 16D form at precise boundary locations in the horizontal plane by a drop-on-demand device 18, similar to an ink jet print head, wherein the drops 16D solidify or cure upon or shortly after landing at the specified locations to thereby define the boundary or boundaries of the model material 22 on each layer 12. The precise drop-by-drop deposition of the sacrificial mold material 16 thereby allows the system to achieve a high degree of precision in defining the boundary or boundaries of the surfaces of the part or finished model 10 and the “finish” or surface characteristics of the subsequently deposited model material 22. It must also be noted that the drop-by-drop deposition of sacrificial mold material 16 is required only for the boundary or boundaries that define a surface of the subsequently applied model material 22. It should also be noted that this method significantly reduces the volume of sacrificial mold material 16 that must be deposited on a drop-by-drop basis, thereby significantly reducing the time required to form the sacrificial mold that, in turn, defines the volumes of model material 22 comprising the actual finished model 10.

Next considering the deposition of model material 22 in further detail, as described the model material 22 is deposited within the regions 22R defined by the sacrificial mold material 16 on a layer 12, wherein the regions 22R will include the interior spaces 28S of the grid 28. The model material 22 is deposited in a liquid form to fill the one layer deep cavities or regions delineated by the boundary or boundaries of the sacrificial mold material 16 and, again, the model material 22 solidifies or cures after soon after it is deposited and has conformed and bonded to the previously deposited sacrificial mold material 16 and the model material 22.

In the presently preferred embodiment of the method, the model material 22 is deposited as a spray 22S by a spray device which moves in the X-Y plane, whereby model material droplets are deposited in and over all cavities previously created or defined by the sacrificial mold material 16, to a level that is at least equal to or exceeds the thickness of the current model layer 12. While the exact location of any particular model material 22 droplet is not precisely controlled, the droplets in aggregate are deposited with sufficient accuracy to ensure that any desired location in the X-Y coordinate system can be filled with the requisite amount of model material 22.

In the same general manner as the sacrificial support material 16, additional model material 22 may be deposited beyond that which is required to form the volumes comprising the model. For example, support elements 26 for overhanging, cantilevered and/or undercut regions of the model material 22 may be provided by additional model material 22 being deposited as support material to provide a platform or support on which sacrificial mold material 16 or model material 22 defining the overhanging, cantilevered and/or undercut surfaces of the composite model 10C or the finished model 10 can later be deposited. In this regard, and as discussed further below, the additional material used as a support structure can be fabricated entirely of sacrificial mold material 16, or as described above can be fabricated as a three dimensional grid 28 of sacrificial mold material 16 with the interior spaces of the grid 28 being subsequently filled by model material 22.

In a further example, voids 30 between parts of a finished model 10, that is, and for example, regions of the layers 12 not occupied by the actual finished model 10, or hollow spaces within a finished model 10 that connect with the exterior, may be filled during fabrication with “filler elements” 32 of model material 22 bounded and separated by walls, ceilings and floors comprised of sacrificial mold material 16. Again, each filler element 32 would be formed by laying down a “floor” on one layer, laying down successively stacked boundary walls on succeeding layers, and laying down a final “ceiling” on the uppermost layer of the filler element 32. Subsequent removal of the sacrificial mold material 16 will then result in separation or disconnection of the filler elements 32 of model from one another and from the remaining portions of the finished model 10 so that the filler elements 32 can then fall away to leave open spaces or voids between or within portions of the finished model 10. Again, it should also be noted that a filler element 32 need not be a cubical or rectilinear shape, but can be of any desired shape necessary to conform to adjacent surfaces of the composite model 10C or finished model 10 including, for example, rectangles, wedges and curved or slanted variants thereof and any curved shape that can be defined by the drop-by-drop deposition of sacrificial mold material 16, including shapes that are slanted or curved in two or three dimensions. In summary, the size and shape of the filler elements 32 or grid 28 elements is dependent on the geometry of the model and the filler elements 32 used to fill a small space or void or a semi-enclosed volume of the finished model 10 must be small enough to pass the through the available opening or openings of the filled space or semi-enclosed volume to permit removal thereof.

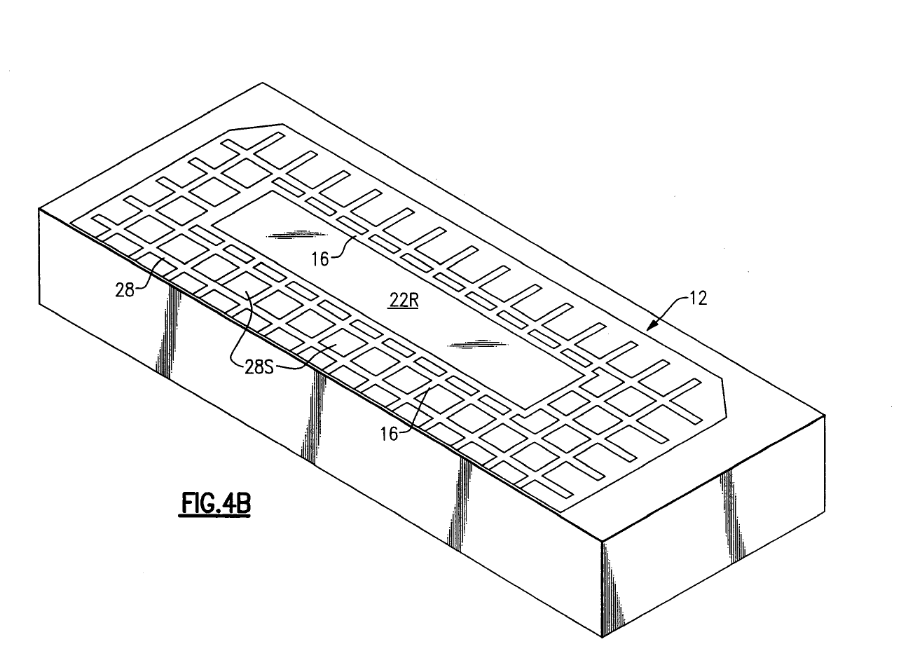

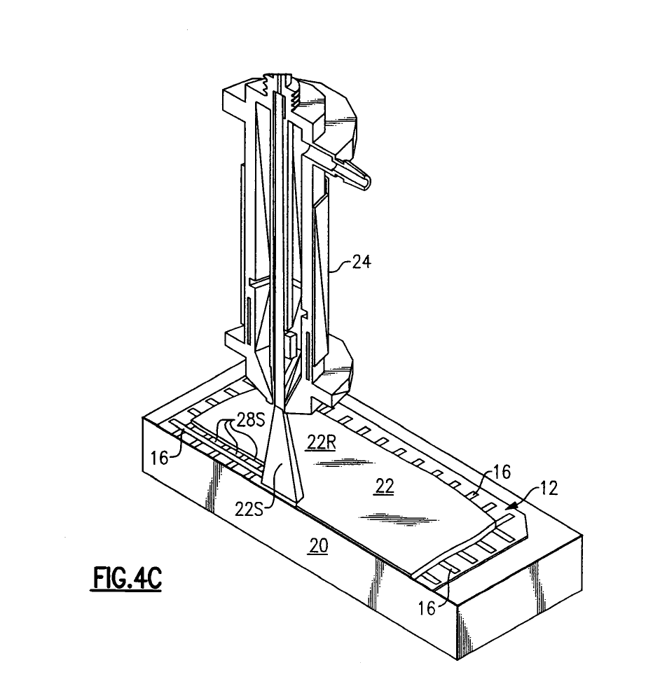

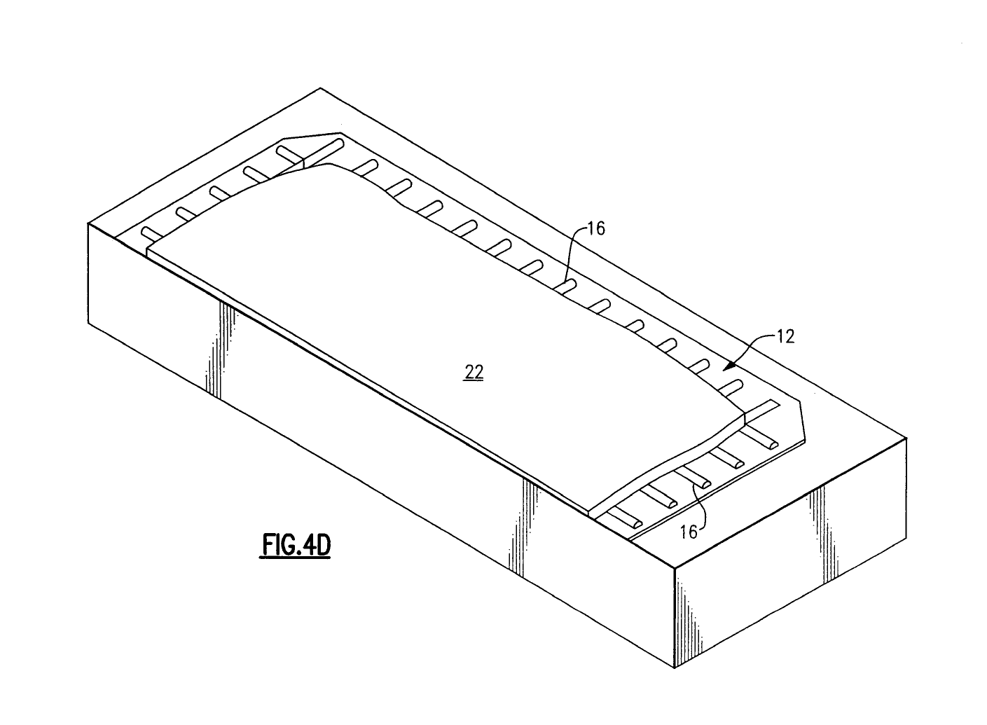

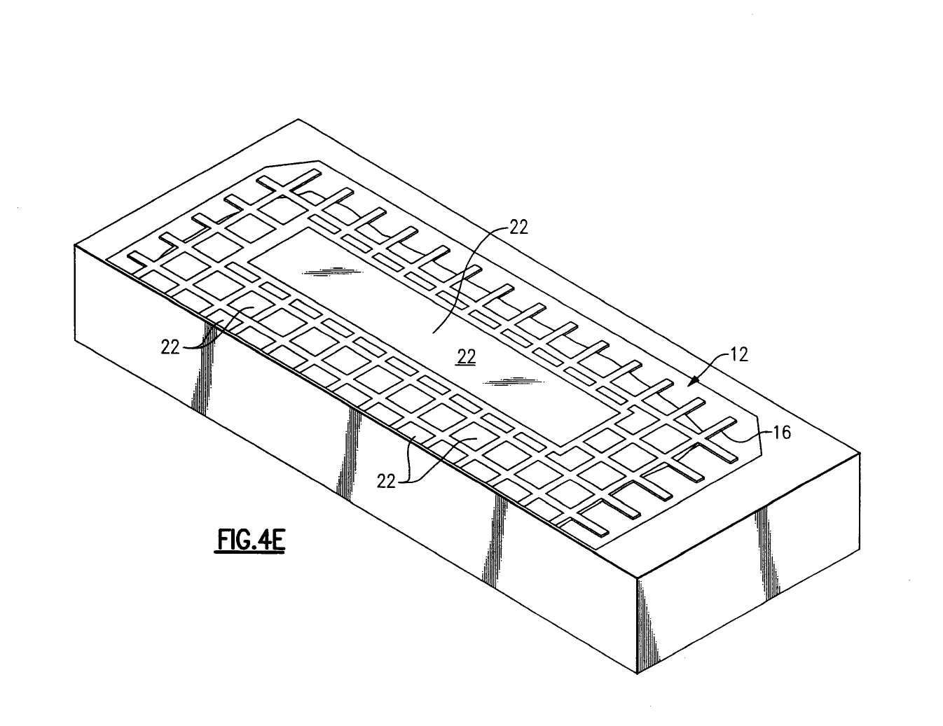

The above described process for constructing a composite model 10C is summarized and further illustrated in FIGS. 4A-4E. As shown in FIG. 4A, and as described, the construction of a layer 12 begins with the drop-by-drop deposition of drops 16D of sacrificial mold material 16 onto a previously existing layer 12, or the base 20, to delineate the regions 22R to be filled with model material 22, thereby defining the boundary or boundaries of the model material 22 and thus the surfaces of the finished model 10. As described, regions 22R include grid spaces 28S of a grid 28 that defines the boundaries of filler elements 32 used, for example, to fill voids 30 with removable model material 22.

As illustrated in FIG. 4B, the result of this first step of the process is a support structure comprised of lines of sacrificial mold material 16 that were deposited on a drop-by-drop basis and that define a central region 22R and a plurality of grid spaces 28S that are to be filled with model material 22.

In the next step, illustrated in FIG. 4C, a spray device 24 deposits a layer of model material 22 over the regions 22R of the layer 12 to be occupied by model material 22 as a spray 22S wherein the sprayed model material 22 is deposited to fill the central region 22R and grid spaces 28S defined by a grid 28, if any. As illustrated in FIG. 4D, the spray device 24 covers the regions 22R of the layer 12 to a depth sufficient to fill the one layer deep cavities or regions delineated by the sacrificial mold material 16.

It must be noted with respect to the spraying of model material 22 onto a layer 12 that in certain circumstances the model material 22 may be sprayed onto the entire surface of the layer 12, such as when the areas of the layer 12 are to be comprised, for example, of filler elements 32 or a temporary support element 26 similarly comprised of filler elements 32 or formed by grids 28, that are to be later freed from each other and from surrounding surfaces by the removal of the mold material 16 boundaries separating the individual filler elements 32 or grid 28 elements. In general, however, model material 22 is preferably not deposited in regions or areas that are not to be occupied by model material 22 in the final model 10 unless the model material 22 in such regions or areas is subdivided into removable elements by boundaries or surfaces comprised of mold material 16 because it is often difficult to remove larger regions or areas of model material 22. In as much as the depositing of mold material 16 lines to form grids or filler elements 32 of model material 22 is a time and operation intensive process, it is generally preferable to deposit model material 22 only into those areas or regions that are to be comprised of model material 22 in the finished model 10, or where it is otherwise necessary to construct grids or filler elements 32 of model material 22 to be subsequently removed.

In the final step, the newly deposited layer 12 is planed, by a conventional cutting device 34, to a desired thickness, with the planed material being removed by a vacuum source, so that the newly deposited layer 12 is, as illustrated in FIG. 4E, comprised of lines of sacrificial mold material 16 delineating spaces and regions filled by model material 22. This process is repeated, layer by layer, until the composite model 10C is completed, at which time the sacrificial mold material 16 is removed thereby to leave the finished model 10 comprised of model material 22.

Next considering the sacrificial mold material 16 and the model material 22 themselves, the sacrificial mold material 16 can consist of one or more materials that can be deposited simultaneously or sequentially by drop-by-drop ejection or emission by a drop-on-demand device 18. The characteristics of the sacrificial mold material 16 or materials must be such that sacrificial mold material 16 solidification or curing will occur during or after deposition of the drops 16D to allow each drop 16D to conform to its intended position and to bond to preceding neighboring drops, and the solidification or curing can be the result of physical or chemical processes, depending on the characteristics of the sacrificial mold material 16.

In a like manner, the model material 22 can consist of one or more materials that can be deposited simultaneously or sequentially as a spray 22S of fine droplets and, again, the model material 22 solidification or curing can be the result of physical or chemical processes which occur during or after deposition of the model material 22 to allow the model material 22 to conform to and bond to the previously deposited sacrificial mold and model material.

The characteristics of the sacrificial mold material 16 and the model material 22 must differ mechanically or chemically in such a way, however, that the sacrificial mold material 16 can be selectively removed after the fabrication of the part or structure is completed. For example, in some implementations the sacrificial mold material 16 may have a lower melting temperature than the modeling material 22 so that the sacrificial mold material 16 can be removed by raising the composite model 10C to an appropriate temperature, or may be dissolvable by a solvent that affects the sacrificial mold material 16 but does not affect the modeling material 22, so that the sacrificial mold material 16 can be dissolved away by the solvent.

In presently preferred example embodiments of the system and apparatus of the present invention, the sacrificial mold material is comprised of a crystalline wax-based substance and the model material is comprised of a thermoplastic substance. The sacrificial mold material is deposited on a drop-by-drop basis employing drops having an average diameter of about 0.003 inch to 0.004 inch and at an average rate of about 0.5 KHz to 15 KHz at a temperature of about 115° C. and over an average emitter to layer distance of about 0.090 inch to form a line having a width of about 0.015 inch.

The model material is deposited as a spray of droplets having an average diameter of about 0.0003 inch and at an average rate of about 2.5 picoliters per second at a temperature of about 120° C. and over an average spray emitter to layer distance of about 0.75 inch to 1.25 inch with an included spray angle of 17° to cover a width of about 0.150 inch.

The layers, prior to the removal of excess material, have a thickness of about 0.001 inch to 0.006 inch.

Lastly, it will be recognized that other sacrificial mold materials 16 and model materials 22 may be used that meet the general functional requirements described herein above. For example, the model material 22 may be comprised of a metal or ceramic material in powdered form, either sprayed as a dry substance or suspended in a liquid, and solidified or cured by heat, light, a sintering process or an appropriate chemical agent, thus allowing the fabrication of metallic or ceramic models or parts. The sacrificial mold material 16 will, in turn, typically be selected to have characteristics complementary to the model material 22, such as being cured or removable by different processes, such as at different temperature or by different solvents or any combination thereof. For example, possible sacrificial mold materials 16 appropriate for use with a ceramic or a metal model material 22 include, for example, micro-crystalline wax and thermoplastics materials.

In summary, the method and system described in U.S. Patent Publication No. 2007/0029693 A1 and forming the base method and system for the present invention provides an improved finished product compared to systems and methods of the prior art. That is, and for example, the drop-by-drop deposition of sacrificial mold material 16 provides an improved surface finish because of improved and more accurate control of the surface dimensions and finish. In addition, not only does the spray deposition of model material 22 over large areas of each layer 12 significantly reduce the time required to fabricate a model 10, but the spray deposition of model material 22 “floods” the previously deposited mold of sacrificial mold material 16, thereby ensuring improved conformance between the model material and the sacrificial mold material and, again, more accurate control of the surface dimensions and finish.

B. Method and Apparatus of the Present Invention

As described herein above, the method and apparatus of the present invention for fabricating three dimensional models is an further development and improvement of the method and apparatus for fabricating three dimensional models described U.S. Patent Publication No. 2007/0029693 A1 and addresses certain disadvantages or inefficiencies of the previously discussed methods and apparatus.

For example, in the previously described method and apparatus for fabricating three dimensional models, the mold material 16 is confined to use only as a sacrificial boundary material and the model material 22 is confined to use only as the permanent material forming the final model 10. Such restrictions, in turn, severely restrict the manner in which a composite model 10C may be fabricated and, for example, requires the use of “cubes” formed of model material 22 encased in mold material 16 to fabricate temporary supports and voids.

In the method of the present invention as described below, however, a composite model 10C and a final model 10 are fabricated from a drop-on-demand material 116 and a rapid deposition material 122, either or both of which may be used as either the sacrificial material or the permanent material. This allows significantly increased flexibility in forming the final model from the drop-on-demand and the rapid deposition materials because the drop-on-demand material and the rapid deposition material may both be used as either permanent model material or as the sacrificial material. This, in turn, reduces the volume of drop-on-demand material required to form a model and the number of operations required to form the model, thereby reducing the time required to fabricate a model.

In further example, in the methods and apparatus described in U.S. Patent Publication No. 2007/0029693 A1the outer surfaces of a model 10 are formed only by the surfaces of model material 22 after the removal of the sacrificial drop-on-demand material 16, so that the dimensional accuracy and surface finish of the model 10 are a function not only of the characteristics of the mold material 16 and model material 22 themselves, but also of the accuracy with which the mold surfaces are formed, the quality and properties of the mold surfaces formed by the drop-on-demand material 16, and the conformance between the model material 22 and the drop-on-demand material 16. In this regard,the characteristics of the drop-on-demand material 16 and the rapid deposition material 22 surfaces are determined, to a significant degree, not only by the characteristics of the materials themselves, but also by the process by which the drop-on-demand material 16 boundaries and structures are created.

It has been found, however, that, for the fabrication of a given model 10 and because of factors that at present may not be entirely identified and understood, the surface having the desired finish characteristics may in any particular instance be comprised of the surface of the mold material or the drop-on-demand material rather than the surface of the model material or the rapid deposition material.

The method and apparatus of the present invention comprises an improvement of and further development of the method and apparatus described in U.S. Patent Publication No. 2007/0029693 A1 by allowing the final, finished surface of the model 10 to be comprised of either the rapid deposition material 122 or the drop-on-demand material 116, depending upon which material surface is found to provide the final model 10 surface having the desired dimensional accuracy and surface finish.

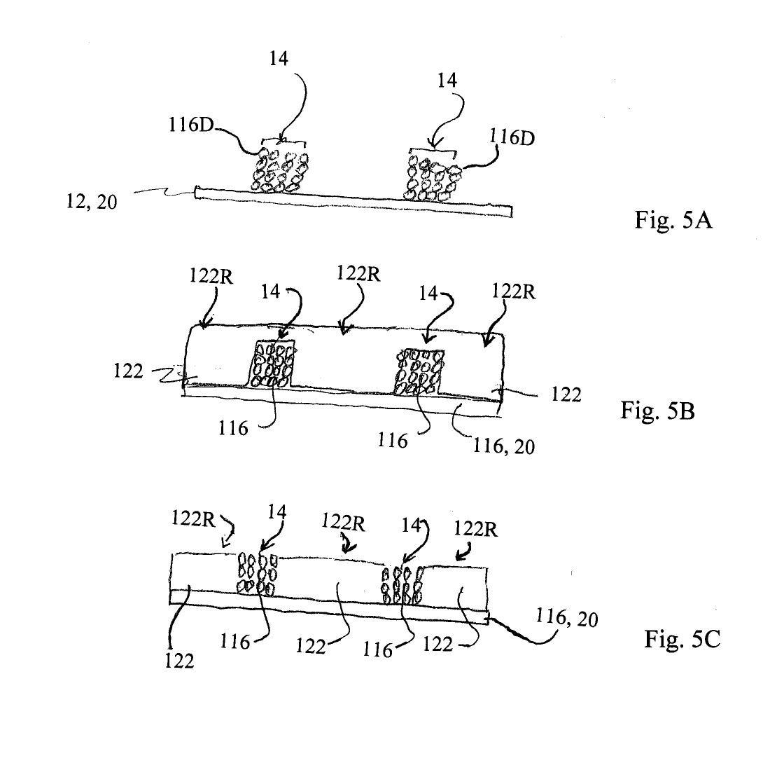

Therefore considering the method of the present invention for constructing a composite model 10C and model 10 in greater detail, the method of the present invention is illustrated in FIGS. 5A-5C wherein, as shown in FIG. 5A, the initial steps of the process comprise the construction of successive layers 12. The first step (36A) in the construction of each layer 12 is again the drop-by-drop deposition of drops 116D of the sacrificial drop-on-demand material 116, either onto the base 20 or onto a previously existing layer 12, to form a drop-on-demand material 116 structure of lines, curves, segments or areas 14 delineating the boundary or boundaries of regions 122R that are to be occupied rapid deposition material 122.

In this regard, it must be noted that, as illustrated in FIG. 5A, it has been found that while the width of any given region or area 14 of drop-on-demand material 116 may again be a small as one drop 116D wide, it has been found preferable in many instances that the width and/or thickness of a given region or area 14 be at least 2 to 6 or more drops 116D in width or in thickness to prevent any unwanted leakage or seepage, for example, of a rapid deposition material solvent, through cracks, voids and/or crevices in the drop-on-demand material 116, into areas or regions of rapid deposition material 122. For example, and referring to the above example of the removal of a temporary support element 26, the support element 26 is comprised of rapid deposition material 122 and is to be removed, such as by an appropriate rapid deposition material solvent, while leaving the second region of rapid deposition material 122 in place. In this case, the line, wall or boundary of solvent resistant material, that is, of the drop-on-demand material 116, must be of sufficient integrity or thickness to prevent any leakage and/or seepage of the solvent, for the rapid deposition material 122, through the wall of the drop-on-demand material 116 into the second region of the rapid deposition material 122, i.e., any leakage or seepage of the solvent for the rapid deposition material 122 through the wall of the drop-on-demand material 116 to the second region of the rapid deposition material 122 will initiate dissolving of the rapid deposition material 122 encased by the drop-on-demand material 116 and this to be prevented by a sufficiently thick boundary layer of the drop-on-demand material 116.

It has been found that a line, region or area 14 of drop-on-demand material 116 within a given layer 12 may be constructed to have a suitable width, thickness and/or height of, for example, 2 to 6 or more drops 116D wide or thick. In general, and depending upon the characteristics of the drop-on-demand material 116, the height, thickness and/or width of a line, region or area 14 of drop-on-demand material in a layer 12 may be generally proportional to the width of the line, region or area of drop-on-demand material 116. For example, a line, region or area of drop-on-demand material 116 may have a width of 2 to 6 or more drops 116D and may have a corresponding height of 2 to 6 or more drops 116D, depending upon the characteristics of the specific drop-on-demand material 116.

In the second step 36B of construction of a layer 12, illustrated in FIG. 5B, a layer of rapid deposition material 122 is deposited by a spray process or, in alternate embodiments, by any rapid deposition device or method, including for example, a roller or rollers, a squeegee or squeegees, a brush or brushes, and so on. In contrast from the method described in U.S. Patent Publication No. 2007/0029693 A1, however, and because the method of the present invention permits and includes the removal of rapid deposition material 122 from selected areas, the depositing of rapid deposition material 122 is not limited to only those regions 122R intended to be formed of rapid deposition material 122 in the finished model 10. The rapid deposition material 122 is instead deposited over the entire area of the layer 12, or over at least significant areas of the layer 12, including areas from which the rapid deposition material 122 is subsequently removed, such as by an appropriate rapid deposition material 122 solvent. As illustrated, the rapid deposition material 122 covers the layer 12, or at least selected areas of the layer 12, to a depth generally equal to or slightly greater than the maximum height of the lines, regions, areas or boundaries formed by or covered by the drop-on-demand material 116, thereby insuring that there are no unwanted voids or holes in the rapid deposition material 122 of the finished model 10.

In the third step 36C of the method of the present invention, illustrated in FIG. 5C, the newly deposited layer 12 is planed to a desired thickness, and the planed material is removed so that the newly deposited layer 12 comprises lines, areas, regions or boundaries 14 of the drop-on-demand material 116 delineating spaces and regions filled by the rapid deposition material 122.

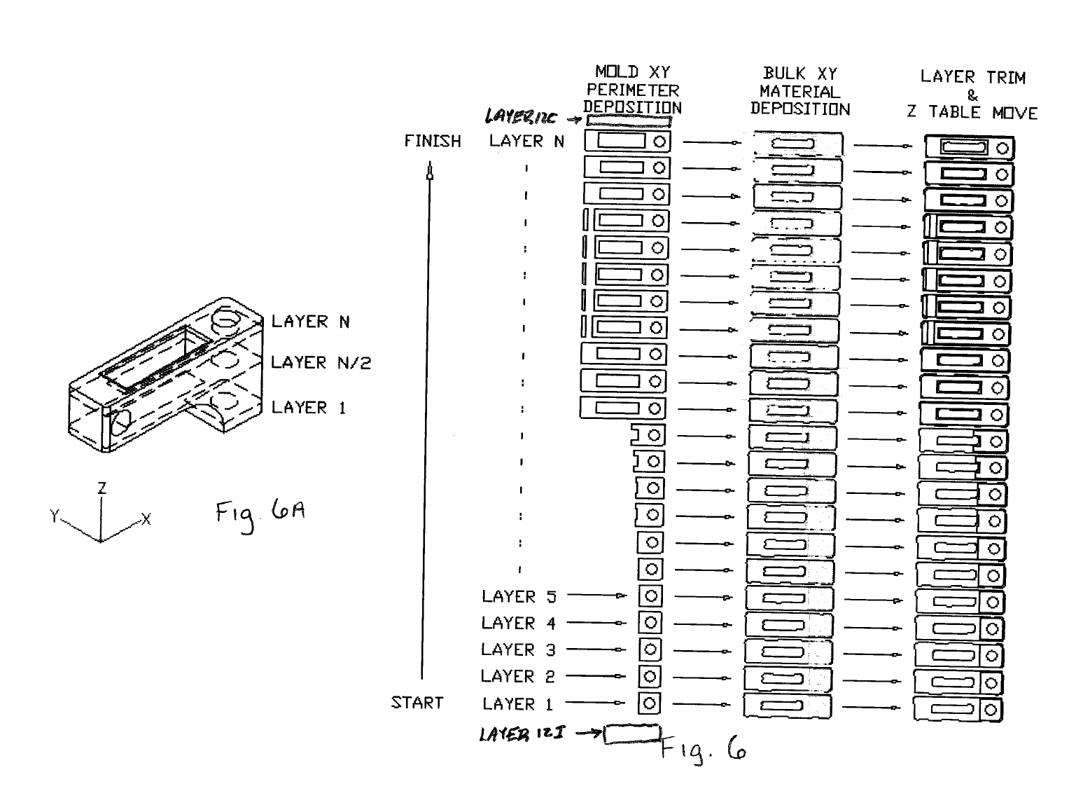

Steps 36A-36C are repeated, layer by layer, until the desired composite model 10C is finally completed, starting with an initial layer 1121 of drop-on-demand material below the lowest layer 1121 of the composite model 10C and finishing with a final “close off” layer 12C of the drop-on-demand material or rapid deposit material on to of the uppermost layer 112 of the model 10C. FIG. 6 shows the deposition of both the perimeter drop-on-demand material 116 which is followed by the bulk rapid deposition material 122 and then the subsequent planing of a small portion of the mostly recently deposited layer. For Layer 1, for example, the perimeter drop-on-demand material 116 is first deposited and this is then followed by the bulk rapid deposition material 122 and a subsequent planing of a small portion of both the drop-on-demand material 116 and the rapid deposition material 122. This process is repeated for Layers 2, 3, 4, 5 . . . n until the desired composite model 10C, shown in FIG. 6A, is completed.

In an alternate embodiment of the above described steps for constructing composite model 10C, successive perimeters or boundaries of drop-on-demand material 116 are successive deposited on the layer under construction with the top of each successive layer of the perimeters or boundaries of drop-on-demand material 116 being planed to a desired height, until a desired cumulative height of the perimeters or boundaries is reached. The interior regions or spaces within the perimeters or boundaries is then filled with the rapid deposition material 122 to the desired cumulative height, with the composite layer then being planed to a final height as necessary. It will be appreciated that this alternative implementation of the method of the present invention still further reduces the time and number of operations required to fabricate a composite model 10C by reducing the number of operations required to deposit the rapid deposition material 122 of the successive layers of the composite model 10C.

In a still further embodiment, successive perimeters or boundaries of drop-on-demand material 116 are successive deposited on the layer under construction until a desired cumulative height of the perimeters or boundaries is reached. At this point, the interior regions or spaces within the perimeters or boundaries are then filled with the rapid deposition material 122 to the desired cumulative height, and the accumulated composite layers of drop-on-demand material 116 and rapid deposition material are then planed to a final height, as necessary. In still further embodiments of this process, the deposited lines of first material may be planed at one or more intermediate heights during the process of building the perimeters or boundaries of the first material to the desired final cumulative height, and the perimeters or boundaries of first material may be planed to the desired cumulative height after depositing a final line or lines of first material and before the deposition of the second material.

Upon completion of the fabrication of the composite model 10C as described above, the sacrificial regions of drop-on-demand material 116 and/or rapid deposition material 122, that is, those regions or volumes of the drop-on-demand material 116 and/or the rapid deposition material 122 that are not to be included in the final model 10, are then removed during sequence of steps 38, for example, by the application of appropriate corresponding solvent, to thereby leave the final model 10 which may comprise regions or volumes of the rapid deposition material 122, or both materials. It will be understood in this regard that the location and organization of the regions or volumes of the drop-on-demand material 116 and the rapid deposition material 122 in a composite model 10C, and the sequence of their fabrication, will be determined by the desired structure and composition of the final model 10 and the sequence in which the sacrificial regions or volumes of the drop-on-demand material 116 and the rapid deposition material 122 are removed from the composite model 10C, as well as the means by which the materials are removed from the model 10, such as by a solvent(s), temperature or a combination thereof.

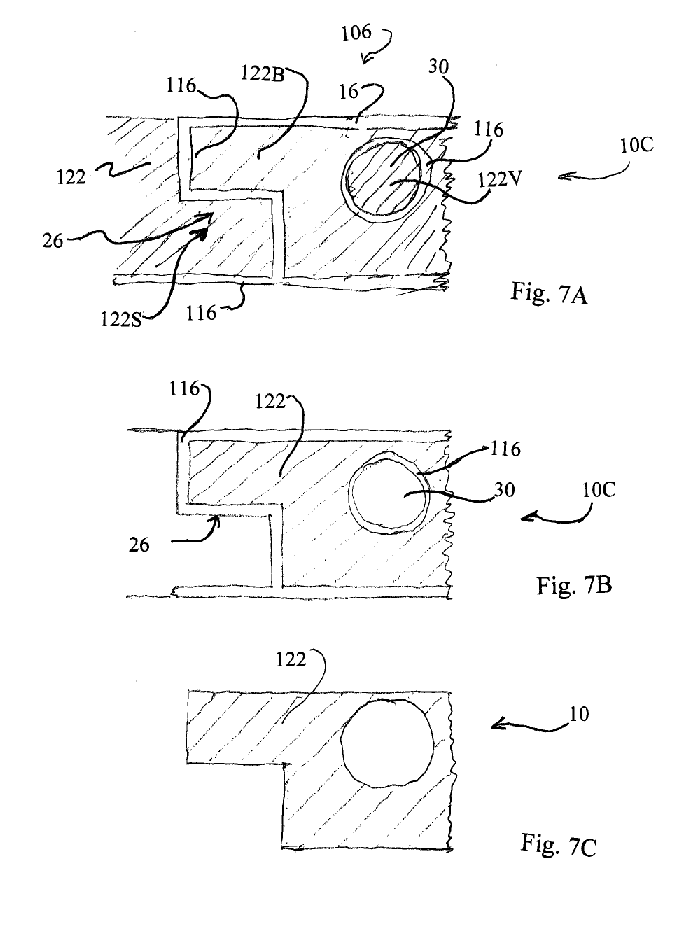

An illustrative example of steps 38S and 38B are illustrated in FIG. 7A-7C in which FIG. 7A is a diagrammatic cut away, cross sectional view of a portion of an exemplary composite model 10C at the completion of steps 36A-36C. It is to be understood that the process shown in FIGS. 7A-7C is purely illustrative of the general method and is not to be taken as definitive of or as limiting the described method.

As represented therein, a composite model 10C may typically include regions filled with rapid deposition material 122, including a region 122S forming a support element 26 for an overhanging section of the structure and a body region 122B including a void 30 filled with rapid deposition material 122V, each of which are separated from one another by walls or surfaces comprised of drop-on-demand material 116.

FIG. 7B (Step 38A) illustrates a step 38A the composite model 10C after the first step 38 of removal of a sacrificial material, e.g., the rapid deposition material 122 for example, from the composite model 10C. In this step, and by way of illustrative example, the volume of rapid deposition material 122S forming the support element 26 and the volume of rapid deposition material 122V forming the interior of the void 30 have been removed by, for example, the application of solvent designed only to dissolve the rapid deposition material 122 but not the drop-on-demand material 116. It will be noted that the body of the rapid deposition material 122, forming body region 122B, has been protected from the solvent for the rapid deposition material by a sufficient thickness or layer of the drop-on-demand material 116, leaving at this stage a body region 122B of the rapid deposition material 122 encased within and by the drop-on-demand material 116 and containing a void 30 having a wall formed of drop-on-demand material 116.

FIG. 7C (Step 38B) illustrates the final step of the example where it is assumed that the desired surface of the final model 10 is formed by the exterior surfaces of the rapid deposition material 122, that is, the surfaces of body region 122B. To facilitate this, therefore and for example, a solvent for the drop-on-demand material is next applied to the composite model 10C and this solvent removes the walls and boundaries formed of the drop-on-demand material 116, thereby leaving a final model 10 having a body region 122B formed completely of the rapid deposition material 122 and with the surfaces of the model 10 being formed by the exterior surface of the rapid deposition material 122.

According to the present invention, either the outwardly facing exterior surface of the drop-on-demand material 116 or the inwardly facing interior surface of the drop-on-demand material 116 defines the exterior surface of the model 10 being formed. If the outwardly facing exterior surface of the drop-on-demand material 116 defines the exterior surface of the model 10 being formed, this simplifies the manufacturing process as only one solvent is necessary to dissolve and remove any rapid deposition material 122, which is not enclosed by the drop-on-demand material 116, to thereby result in the finished model 10. Such one step dissolving process further streamlines and improves the overall efficiency of the manufacturing process for the desired model 10. When designing the model 10 being formed, it must be known which surface, i.e., either the outwardly facing exterior surface or the inwardly facing interior surface, of the drop-on-demand material 116 is to define the exterior surface of the model 10 to be manufactured.

As is to be appreciated by the above, if the inwardly facing interior surface of the drop-on-demand material 116 defines the exterior surface of the model 10 being formed, then a subsequent dissolving process is necessary to dissolve away the drop-on-demand material 116 thereby solely leaving the model 10 to be manufactured which typically comprises solely the rapid deposition material 122.

Considering further embodiments of the present invention, it has been described herein above that a composite model 10C may be constructed of three materials wherein at least two of the materials may be separated from the composite model by successive removal processes removal wherein each removal process includes the removal of one of the first material, the second material and the third material, by a corresponding removal method, in which at least one of the removal methods will not effect one or both of the other first, second and third materials. In certain embodiments, for example, there may be a different removal process for each material and each material may be removed only by the corresponding removal process. In other embodiments, one removal process may remove two of the three materials and the remaining material may be effected only by a separate removal process. In this latter instance, and for example, the use of three materials allows greater flexibility in the fabrication of a composite model and the use of a single removal process for two materials allows those two materials to be removed from the composite model during a single removal operation.

A diagrammatic illustration of the construction of a composite model 10C and model 10 using three materials is illustrated in FIGS. 8A-8E. As shown therein, the method of the present invention for constructing a composite model 10C and model 10 using three materials includes aspects and steps that are similar to the method described above with reference to FIGS. 5A-5C, 6 and 7A-7B for the construction of a composite model 10C and model 10 using two materials, at least one of which may be removed by a process not effecting the other material.

In the processes illustrated in FIGS. 8A-8E, the three materials are designated as a first material 124A, a second material 124B and a third material 124C wherein at least one of materials 124A, 124B or 124C is a drop-on-demand material, at least one other material of materials 124A, 124B or 124C is a rapid deposition material, and the third of materials 124A, 124B or 124C may be either a drop-on-demand material or a rapid deposition material. It will be understood that the designations of materials 124A, 124B and 124C as drop-on-demand materials or rapid deposition materials, in the following discussions, is solely for purposes of illustration and discussion and is not to be taken as restrictive or as limiting, for example, a material 124A to being a drop-on-demand material, and so forth. It must also be noted that, as discussed above, at least two of materials 124A, 124B or 124C may be separated from the composite model 10C by successive removal processes wherein the removal process for a given one of materials 124A, 124B or 124C does not effect either of the other two materials.

As illustrated in FIG. 8A, the first step 40A of the construction of a composite model 10C comprises the first material 124A, the second material 124B and the third material 124C includes the drop-on-demand deposition of one or more lines of the first material 124A to delineate and form at least one boundary 126A of at least one first area 128A. In a second step 40B, illustrated in FIG. 8B, the second material 124B is deposited onto at least selected ones of the at least one first area 128A by a high speed deposition process, as discussed previously. Third step 128C, illustrated in FIG. 8C, typically comprises the high speed deposition of the third material 124C onto second areas 128B wherein second areas 128B may include, for example, areas outside the boundaries 126A defining first areas 128A or first areas 128A that were not filled with the second material 124B, in step 128B.

In further implementations of the three material fabrication method of the present invention, such as illustrated in FIGS. 8D and 8E, third step 128C may instead comprise a fourth step 128D comprising the drop-on-demand deposition of one or more lines of the first material 124C to delineate and form at least one boundary 126C of at least one third area 128C and a fifth step 128E comprising the high speed deposition of the second material 124B into at least selected ones of at least one third area 128C or onto the regions outside of the areas 128A and 128B.

It should be noted that, for example, third step 40C may be implemented as a fourth step 40D and a fifth step 40E, that the areas 128B and 128C may, for example, define either or both of structural supports for subsequent layers 12 and elements of the composite model 10C, including elements of the finished model 10, and, in the first case, will typically fall within or under the boundaries of first areas 128A and second areas 128B.

Further with regard to the three material process illustrated in FIGS. 8A-8E, it must be noted that this process will again include the step or steps of planing the layer 12 being deposited to the desired thickness and that the planing operation may again be performed, for example, after the deposition of each one of the materials 124A, 124B and 124C onto the layer 12 or after the materials 124A, 124B and 124C have all been completely deposited, or by any combination of deposition and planing steps between these extremes. In a like manner, the step or steps of depositing the rapid deposition material or materials and the planing of the deposited lines and layers of drop-of-demand and rapid deposition materials may be performed after each line of the drop-on-demand material or materials has been deposited or after the perimeters or boundaries of drop-on-demand material or materials has reached a specified cumulative height.

Lastly, the final model 10 is separated from the composite model 10C resulting from the above described steps illustrated in FIGS. 8A-8E by successive removal processes in which, as described above, the materials 124A, 124A and 124C, and their corresponding removal methods, are selected so that the removal process for a given one of materials 124A, 124B or 124C does not effect either of the other two remaining materials. As also described herein above with respect to two material processes, the removal processes may include chemical solvents or reagents, irradiation methods, material phase changes with temperature, such as from a solid to a liquid or gas, and so on, and any combination thereof. It will be apparent that the sequence in which the materials 124A, 124B and 124C are removed from the composite model 10C will be dependent on, for example, the function performed by each area, region or boundary, that is, as a support element, a mold form enclosing an element of the final model 10, or an element of the final model 10, the order in which the materials are deposited, and so forth.

For example, and for purposes of illustration, a composite model 10 may be constructed according to steps 128A, 128C and 128C wherein step 128C is a single step in which the third material 124C is deposited by a rapid deposition onto second areas 128B that include, for example, areas outside the boundaries 126A defining first areas 128A or the first areas 128A that were not filled with the second material 124B in step 128B. In this case, and again for example, the third material 124C is first removed from the first material 124A by a method that does not effect the first material 124A. The first material 124A may then be removed from second material 124B by a method not effecting second material 124B, thereby resulting in a final model 10 formed exclusively of second material 124B. Alternatively, the first material 124A may remain to form the surface of a model 10 in which an exterior shell of the first material 124A is generally filled with the second material 124B.

It will be appreciated by those of ordinary skill in the relevant arts, after the above description of a three material embodiment of the present invention, that a three material embodiment provides greater flexibility and more complex arrangements and uses of the various materials in fabricating a composite model 10C and a finished model 10. For example, a third material 128C may be employed to construct additional supporting elements or void filling material that may, for example, be retained while the model 10 with retained third material is assembled with other components and subsequently removed after the assembly is completed. It will be appreciated that the flexibility and versatility of the method may be extended still further by, for example, providing both drop-by-drop and rapid deposition devices for one or two or all of the materials, thereby allowing each material to be used for a variety of roles and allowing the fabrication of more complex structures and sequences of material deposition and removal.

Since certain changes may be made in the above described apparatus for fabricating three-dimensional models using a spray device without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. A method for fabricating a three dimensional model, the method: comprising the steps of:
(1) fabricating a composite model formed of a plurality of successive layers, each layer including at least one of a first material and a second material and each successive layer being formed by the steps of:
a) depositing at least one line of a first material delineating at least one boundary of at least one first area of the layer by a drop-by-drop deposition of the first material wherein the drops of the first material solidify shortly after being deposited to define the at least one boundary of the at least one area;
b) depositing a second material onto at least a second area of the layer by a rapid deposition of the second material wherein the second area includes at least the first area,
c) removing a thickness of at least one of the first and the second materials to reduce the fabricated layer to a selected thickness; and
d) repeating steps (a), (b) and (c) until the composite model is fabricated, and
(2) separating the three dimensional model from the composite model by successive removal processes, with each removal process including the removal of one of the second material and the first material by a corresponding removal method not effecting the other of the first and the second materials.

2. The method for fabricating the three dimensional model according to claim 1, wherein:
step (a) further includes the steps of:
(a1) removing a thickness of the first material to reduce the layer to a selected thickness of the first material defining each boundary of each region; and
(a2) repeating steps (a) and (a1) to construct the outer boundary of at least one region of the layer to a thickness of layers of first material.

3. The method for fabricating the three dimensional model according to claim 1, wherein the step of removing the three dimensional model from the composite model includes successive removal processes for the first and second materials so that exterior surfaces of the final three dimensional model are formed of the first material.

4. The method for fabricating the three dimensional model according to claim 1, wherein the step of removing the three dimensional model from the composite model includes successive removal processes for the second material and the first material so that exterior surfaces of the final three dimensional model are formed of the second material.

5. The method for fabricating the three dimensional model according to claim 1, further comprising the step of:
separating the three dimensional model from the composite model by removing the second material by a process effecting only the second material thereby leaving the first material which forms an exterior shell which defines an exterior surface of the three dimensional model.

6. The method for fabricating the three dimensional model according to claim 1, further comprising the step of:
separating the three dimensional model from the composite model by removing the second material by a process effecting only the second material thereby leaving the first material which forms an exterior shell encasing the three dimensional model; and
subsequently removing the exterior shell of first material encasing the three dimensional model by a process effecting only the first material thereby only leaving the second material which forms the three dimensional model.

7. The method for fabricating a three dimensional model according to claim 1, wherein:
rapid deposition method comprises deposition of the second material by a spray device.

8. A method of fabricating a multi-layered three dimensional model, the method comprising the steps of:
(a) constructing a layer of the model by:
(a1) defining on the layer an outer boundary of at least one region of the three dimensional model by depositing, for each region, a layer of a boundary of a first material enclosing the region;
(a2) filling an interior space of each region with a second material wherein the second material is deposited at a rate faster than a rate than the first material is deposited; and
(a3) removing a thickness of at least one of the first and the second materials to reduce the layer to a selected thickness of the first material;
b) repeating steps (a1) through (a3) until the composite model is completed, and
c) separating the three dimensional model from the composite model by successive removal processes, each removal process including the removal of one of the second material and the first material by a corresponding removal method not effecting the other of the first and the second materials.

9. The method of fabricating the three dimensional model on the layer by layer basis according to claim 8, wherein:
steps (a1) further includes the steps of
(d) removing a thickness of the first material to reduce the layer to a selected thickness of the first material defining each boundary of each region; and
(e) repeating steps (a1 ) and (d) to construct the outer boundary of at least one region of the layer to a thickness of layers of first material.

10. The method of fabricating the three dimensional model on the layer by layer basis according to claim 8, wherein:
in step (a2) the interior space of each region is filled with the second material to a desired thickness and,
in step (a3) a thickness of the second material is removed to reduce the layer to the selected thickness.

11. The method of fabricating the three dimensional model on the layer by layer basis according to claim 8, further comprising the step of using a rapid deposition device for depositing the second material at the rate faster than the rate than the first material is deposited.

12. The method of fabricating the three dimensional model on the layer by layer basis according to claim 8, further comprising the step of providing the spray jet device with a propellant for propelling the second material and a separate delivery and temperature control for controlling a temperature at which the second material is deposited.

13. A method for fabricating a three dimensional model, the method comprising the steps of:
(1) fabricating a composite model formed of a plurality of successive layers, each layer including at least one of a first material and the second material and each successive layer being formed by the steps of
(a) depositing at least one line of a first material delineating at least one boundary of at least one first area of the layer by a drop-by-drop deposition of the first material,
(b) depositing a second material onto at least a second area of the layer by a rapid deposition method of the second material wherein the second area includes at least the first area and the deposition of the second material fills the first area to a level at least as high as the highest layer of the first material boundary,
(c) removing a thickness of at least one of the first material and the second material to reduce the thickness of the layer to a selected thickness of the first material,
(d) repeating steps (a), (b) and (c) until the composite model is completed, and
(2) separating the three dimensional model from the composite model by successive removal processes, each removal process including the removal of one of the first material and the second material by a corresponding removal method not effecting the other of the first and second materials.

14. The method for fabricating a three dimensional model according to claim 13, wherein step (a) further includes the steps of:
(a1) removing a thickness of the first material to reduce the layer to a selected thickness of the first material defining each boundary of each region; and
(a2) repeating steps (a) and (a1) to construct the outer boundary of at least one region of the layer to a thickness of layers of first material.

15. The method for fabricating a three dimensional model according to claim 13, wherein the step of removing the three dimensional model from the composite model includes successive removal processes for the first and the second materials so that exterior surfaces of the final three dimensional model are formed of the first material.

16. The method for fabricating a three dimensional model according to claim 13, wherein the step of removing the three dimensional model from the composite model includes successive removal processes for the first and the second materials so that exterior surfaces of the final three dimensional model are formed of the second material.

17. A method for fabricating a three dimensional model, the method comprising the steps of:
fabricating a composite model from a plurality of successive layers, each layer including al least one of a first material, second and third material and successive layers being formed by the steps of:
(a) depositing at least one line of a first material delineating at least one boundary of at least one first area of the layer by a drop-by-drop deposition of the first material,
(b) depositing a second material onto at least one second area of the layer by a rapid deposition method wherein the at least one second area includes at least one of the at least one first area,
(c) depositing a third material onto at least one third area of the layer by one of a rapid deposition method and a drop-by-drop deposition wherein the at least one third area includes at least one area outside at least one of the at least one first area and the at least one second area,
(d) removing a thickness of the first material, the second material and the third material to reduce the layer to a selected thickness, and
(e) repeating steps (a) through (d) until the composite model is completed, and
(f) separating the three dimensional model from the composite model by first and second successive removal processes, each of the first and the second successive removal processes including the removal of one of the first material, the second material and the third material by a corresponding removal method wherein at least one of the removal methods will not effect at least one of another of the first, the second and the third materials.

18. The method for fabricating the three dimensional model according to claim 17, wherein:
step (a) further includes, prior to proceeding to step (b), the steps of
(a1) removing a thickness of the first material to reduce the layer to a selected thickness of the first material; and
(a2) repeating steps (a) and (a1) to construct the outer boundary of at least one region of the layer to a thickness of layers of the first material.

19. The method for fabricating a three dimensional model according to claim 17, wherein the step of removing the three dimensional model from the composite model includes successive removal processes for the first, the second and the third materials so that exterior surfaces of the final three dimensional model are formed of the first material.

20. The method for fabricating a three dimensional model according to claim 17, wherein the step of removing the three dimensional model from the composite model includes successive removal processes for the first, the second and the third materials so that exterior surfaces of the final three dimensional model are formed of the second material.

21. The method for fabricating a three dimensional model according to claim 17, wherein the steps of removing the three dimensional model from the composite model includes a common removal process for simultaneously removing the second and the third material which does not effect the first material with external surfaces of the final three dimensional model being formed of the first material.

22. The method for fabricating a three dimensional model according to claim 17, wherein the steps of removing the three dimensional model from the composite model includes a common removal process for simultaneously removing the second material and the third material by a process which does not effect the first material, followed by a separate removing process which removes of the first material but does not effect the second material with external surfaces of the final three dimensional model being formed of the second material.
